(19) United States
(12) Patent Application Publication
(10) Pub. No.: US 2012/0031909 A1
(43) Pub. Date: Feb. 9, 2012

(54) Binary cryogenic media container system

(76) Inventor: Allan M. Weiner, Pompano Beach, FL (US)

(21) Appl. No.: 13/136,449

(22) Filed: Aug. 2, 2011

Related U.S. Application Data
(60) Provisional application No. 61/370,398, filed on Aug. 3, 2010.

(51) Int. Cl. F17C 13/08

(52) U.S. Cl. 220/560.1

(57) ABSTRACT

A storage container for cryogenic media such as liquid nitrogen where the container includes an outside container having at least two internal containers each of which stores cryogenic media at different internal pressures wherein each of the at least two internal containers have means to permit the individual release or filling of cryogenic media for each container.

### CROSS REFERENCE TO RELATED APPLICATIONS

This application claims the benefit of U.S. Provisional Application No. 61/370,398 filed on Aug. 3, 2010. The entire disclosure of that application is incorporated by reference into the disclosure of this document is if fully stated herein.

### STATEMENT REGARDING FEDERALLY SPONSORED RESEARCH

Not Applicable.

### BACKGROUND OF THE INVENTION

Cryogenic liquids are liquefied gases that generally have boiling points below −100 degrees C. (about −150 degrees F.) at atmospheric pressure. Examples of cryogenic liquids include liquid natural gas (LNG), liquid nitrogen, liquid oxygen, liquid argon, liquid methane, and liquid hydrogen. These cryogens are used in a wide variety of industrial, medical, research, and commercial applications. Specific examples of the use of cryogenic media include flash freezing of foods, biological specimen preparation and preservation, environmental testing, and general refrigeration. Other possible uses include applications such as chemical processes, pharmaceutical, heat treatment, metal processing, environmental testing, aerospace, or any other production environment that may require the use of various states of cryogenic media at different pressures.

Storing these cryogenic fluids poses its own set of problems, not the least of which is minimizing heat transfer into and out of the fluid, loss of fluid volume and providing usable access to cryogenic fluids at more than one pressure. The standard cryogenic storage vessel is the classic Dewar named after the inventor Sir James Dewar. The Dewar device is a double vessel with a glass inner wall, an outer wall, and an evacuated space between the inner and outer walls that reduces heat transfer by conduction. In certain applications, an outer layer of metal is sometimes provided. The inner vessel defines the cryogen space in which a cryogenic liquid can be stored.

While a single cryogenic container may work for most applications, there are times when a processor needs cryogenic media that is stored at two or more pressure ranges for two or more processes. For example, while one process application may require lower pressure liquid nitrogen for purposes such as refrigeration, there may also be a need for higher pressure liquid nitrogen for purposes other than refrigeration. Because current standard cryogenic media storage tanks only have one inner tank and do not have the ability to store multiple liquefied gases or liquefied gases at two or more pressure ranges simultaneously, such multi-process users face a number of problems in generating liquid nitrogen at two different pressures.

One possible solution would be to have two separate liquid nitrogen storage tanks at the processor's facility. However, this would be costly and would substantially increase the amount of square footage required by the user to maintain multiple liquid nitrogen storage tanks. This increase in the use of square footage for tanks can also be a very critical issue when space is limited and when real estate costs are high.

### SUMMARY OF THE INVENTION

This section provides a general summary of the disclosure, and is not a comprehensive disclosure of its full scope or all of its features.

In accordance with the various embodiments of the present invention, this invention relates to a system and process for a binary cryogenic media storage system in which a single outer container includes two generally segregated inner containers in which cryogenic media is stored at a higher pressure in one container and at a lower pressure in a second container. Piping is available for the general extraction and filling of cryogenic media for each of the two internal containers. Separate extraction assemblies can be used to independently extract cryogenic media from the inner container having a higher pressure and cryogenic media from the other inner container having a lower pressure.

DESCRIPTION OF THE DRAWINGS

In the accompanying drawings which form part of the specification:

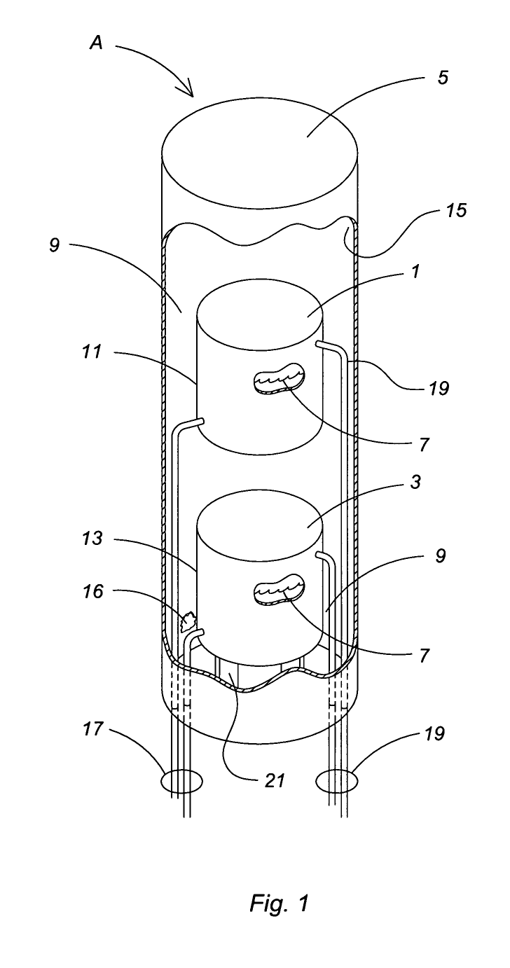

FIG. 1 is a perspective view one embodiment of the present invention.

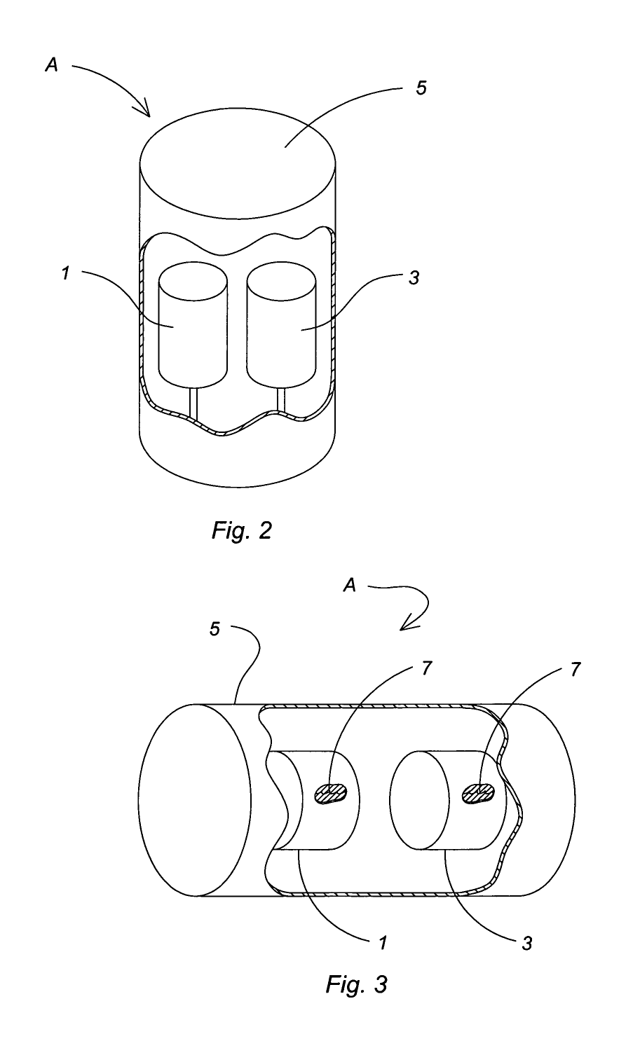

FIG. 2 is a perspective view an alternate embodiment of the present invention.

FIG. 3 is a perspective of yet another embodiment of the present invention.

Corresponding reference numerals indicate corresponding steps or parts throughout the several figures of the drawings.

While specific embodiments of the present invention are illustrated in the above referenced drawings and in the following description, it is understood that the embodiments shown are merely some examples of various preferred embodiments and are offered for the purpose of illustration only and that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION OF AT LEAST ONE PREFERRED EMBODIMENT OF THE INVENTION

In the following description, numerous specific details are set forth such as examples of some preferred embodiments, specific components, devices, methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication, and manufacture for those of ordinary skill.

At least one preferred embodiment of the present invention is illustrated in the drawings and figures contained within this specification. More specifically, certain preferred embodiments of the present invention are generally disclosed and described in FIGS. 1-3.

Referring now to FIG. 1, one embodiment of Binary Cryogenic Media Container System A is shown in FIG. 1 and comprises a first inner container 1, a second inner container 3, and an outer container 5. The first and second inner container 1 and 3 are designed to contain and store a cryogenic media 7. It is noted, however, that the first inner container 1 stores the cryogenic media 7 at a different pressure range than the second inner container 3. For example, the first inner container can have an internal pressure of between about 20 psi and about 60 psi to provide liquid nitrogen for general refrigeration use, while the second inner container can have an internal pressure of greater than about 90 psi to provide liquid nitrogen for uses other than general refrigeration. It is appreciated that either of the first inner container 1 or the second inner container 3 may have the higher or the lower of the two different pressure ranges. The first inner container 1 and the second inner container 3 are deposed within the outer container 5 such that there is a space 9 between a first outer surface 11 of the first inner container 1, a second outer surface 13 of the second inner container 3, and an inner surface 15 of the outer container 5. In many preferred embodiments, the space 9 is substantially filled with a thermal insulating material 16 such as expanded or unexpanded perlite siliceous rock. It is appreciated by those of skill in the art that other thermal insulating materials and methods may also be used while still remaining within the intended scope for the present invention. For example, in alternative embodiments, the first inner container 1 and the second inner container 3 may be wrapped in Mylar® or a similar material. It is also understood that in most preferred embodiments, the space 9 is a vacuum because the presence of a vacuum between the inner containers 1 & 3 and inner wall 15 of the outer container 5 can be advantageous in generating a thermal barrier to insulate the cryogenic media from the ambient temperatures.

Each of the first inner container 1 and the second inner container 3 may have an independent extraction assembly 17 for extracting the liquid media 7 from within the related inner container. Additionally, each inner container 1 and 3 may also have an independent fill assembly 19 for transferring cryogenic media 7 into each of the inner container 1 and 3. In alternative embodiments, the fill assembly 19 may not be independent and is capable of transferring cryogenic media 7 into either the first inner container 1 or the inner container 3 through use of a common fill assembly 19. Additionally, each of the first inner container 1 and the second inner container 3 can have an independent economizer and pressure builder system, safety relief system, and level indicator. However, in certain applications it will be understood that the present invention includes applications where the economizer and pressure builder system, safety relief system, and level indicator may be commonly used by both the first and second inner containers.

In alternative embodiments of the present invention, the Binary Cryogenic Media Container System can include the ability to transfer cryogenic media between the first inner container 1 and the second inner container 3. In such embodiments, it is understood that the necessary piping, valves, and flow control systems for those components are well known in the art and device are understood to be included as needed for any specific application.

It is also understood that the first inner container 1 and the second inner container 3 are maintained within the confines of the outer container 5 by a support system 21. The support system 21 is designed, sized, and configured to support the first inner container 1 and the second inner container 3 in a manner that results in the generation of the space 9 and may be of any general style or shape. For example, in one embodiment of the present invention, the first inner container 1 is disposed above the second inner container 3 as shown in FIG. 1. In an another alternative embodiment, the first inner container 1 may be disposed along side the second inner container 3 as depicted in FIG. 2. In yet another alternative embodiment, the first inner container 1 may be disposed side by side along their respective longitudinal axis as depicted in FIG. 3. It is understood that the specific spatial relationship between the disposition of the first inner container 1 and the second inner container 3 can be in any relationship and still remain within the intended cope of the present invention. It is also understood that the first inner container 1 and the second inner container 3 may be of any size and shape and the individual axis of either inner container, if any, may be in any orientation with the other inner container. The volume of the inner containers 1 and 3 may be of any size depending upon the particular application and installation of the present invention. However, in certain embodiments, it is preferred that the first inner container 1 and the second inner container 3 be capable of storing between about 300 gallons and about 15,000 gallons of cryogenic media, and the pressure within each of the first and second inner containers ranges between about 15 psi to about 250 psi.

In a preferred embodiment, the first inner container 1 is maintained at a first pressure range 23 utilizing a pressure control system which may be comprised of economizer systems and pressure builder systems well known in the art. The second inner container 3 will be maintained at a second pressure range 25 also utilizing pressure control systems which may also be comprised of similar economizers and pressure builder systems.

In the preceding description, numerous specific details are set forth such as examples of specific components, devices, methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication and manufacture for those of ordinary skill. The scope of the invention should be determined by any appended claims and their legal equivalents, rather than by the examples given.

Additionally, it will be seen in the above disclosure that several of the intended purposes of the invention are achieved, and other advantageous and useful results are attained. As various changes could be made in the above constructions without departing from the scope of the invention, it is intended that all matter contained in the above descriptions or shown in the accompanying drawings shall be interpreted as illustrative and not in a limiting sense.

Terms such as “proximate,” “distal,” “upper,” “lower,” “inner,” “outer,” “inwardly,” “outwardly,” “exterior,” “interior,” and the like when used herein refer to positions of the respective elements as they are shown in the accompanying drawings, and the disclosure is not necessarily limited to such positions. Terms such as “first,” “second,” and other numerical terms when used herein do not imply a sequence or order unless clearly indicated by the context.

When introducing elements or features and the exemplary embodiments, the articles “a,” “an,” “the” and “said” are intended to mean that there are one or more of such elements or features. The terms “comprising,” “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It will also be understood that when an element is referred to as being “operatively connected,” “connected,” “coupled,” “engaged,” or “engageable” to and/or with another element, it can be directly connected, coupled, engaged, engageable to and/or with the other element or intervening elements may be present. In contrast, when an element is referred to as being “directly connected,” “directly coupled,” “directly engaged,” or “directly engageable” to another element, there are no intervening elements present. Other words used to describe the relationship between elements should be interpreted in a like fashion (e.g., “between” versus “directly between,” “adjacent” versus “directly adjacent,” etc.).

What is claimed is:

1. A binary cryogenic media container system comprising:
at least two inner containers wherein each of the at least two inner containers define a cryogen space within which a cryogenic liquid can be stored;
an outer container surrounding the at least two inner containers;
a support structure for supporting each of the at least two inner containers within the outer container and for holding the at least two inner containers apart from the outer container, and further comprising an insulating space defined between the outer container and the at least two inner containers; and
an independent cryogenic media extraction assembly for removal of cryogenic media from each of the at least two inner containers.

2. The binary cryogenic media container system of claim 1 wherein one of the at least two inner containers has a first internal pressure and the other of the at least two inner containers has a second internal pressure wherein the first internal pressure is different than the second internal pressure.

3. The binary cryogenic media container system of claim 2 wherein the insulating space is substantially filled with a thermal insulating material.

4. The binary cryogenic media container system of claim 3 wherein the thermal insulating material is one of either an expanded or unexpanded perlite siliceous rock.

5. The binary cryogenic media container system of claim 4 further comprising a flexible insulating material covering the at least two inner containers.

6. The binary cryogenic media container system of claim 4 wherein the insulating space between the at least two inner containers and an inner surface of the outer container contains a vacuum.

7. The binary cryogenic media container system of claim 6 wherein the at least two inner containers comprise a first inner container and a second inner container, and further comprising a cryogenic media filler assembly for transferring cryogenic media into one of either the first inner container or the second inner container.

8. The binary cryogenic media container system of claim 7 further comprising a cryogenic media transfer assembly for transferring cryogenic media between the first inner container and the second inner container.

9. The binary cryogenic media container system of claim 8 wherein the first inner container and the second inner container have a volume of between about 300 gallons and about 15,000 gallons of cryogenic media, and the first inner container and the second inner container are capable of operating at pressures between about 15 psi to about 250 psi.

10. The binary cryogenic media container system of claim 9 wherein the first inner container is in vertical axial alignment with the second inner container and with the vertical axis of the outer container.

11. The binary cryogenic media container system of claim 9 wherein the first inner container is not in vertical axial alignment with the second inner container and with the vertical axis of the outer container, but the vertical axis of the first inner container and the vertical axis of the second inner container are parallel with the vertical axis of the outer container.

12. The binary cryogenic media container system of claim 9 wherein the first longitudinal axis of the first inner container is in horizontal axial alignment with the longitudinal axis of the second inner container and with the horizontal axis of the outer container.

13. A binary cryogenic media container system comprising:
a first inner container and a second inner container wherein each of the first inner container and the second inner container define a cryogen space within which a cryogenic liquid can be stored, and wherein the first inner container has a first internal pressure and the second inner container has a second internal pressure and the first internal pressure is different than the second internal pressure;
an outer container surrounding the first inner container and the second inner container wherein the vertical axis of the first inner container is in vertical axial alignment with the vertical axis of the second inner container and with the vertical axis of the outer container;
a support structure for supporting each of the first inner container and the second inner container within the outer container and for holding the first and second inner containers apart from the outer container;
an insulating space defined between the outer container and each of the first inner container and the second inner container;
a thermal insulating material that substantially fills the insulating space and air is substantially withdrawn from the insulating space to generate a vacuum in the space;
an independent cryogenic media extraction assembly for removal of cryogenic media from each of the first inner container and the second inner container; and a filler assembly for transferring cryogenic media into one of either the first inner container and the second inner container.

14. The binary cryogenic media container system of claim 13 wherein the thermal insulating material is one of either an expanded or unexpanded perlite siliceous rock.

15. The binary cryogenic media container system of claim 14 further comprising a cryogenic media transfer assembly for transferring cryogenic media between the first inner container and the second inner container.

16. The binary cryogenic media container system of claim 15 wherein each of the first inner container and the second inner container have a volume of between about 300 gallons and about 15,000 gallons of cryogenic media, and wherein each of the first inner container and the second inner container are capable of operating at pressures between about 15 psi to about 250 psi.
